(19) United States
(12) Patent Application Publication
(10) Pub. No.: US 2017/0361134 A1
(43) Pub. Date: Dec. 21, 2017

(54) BREATHING APPARATUS

(71) Applicant: PAFTEC TECHNOLOGIES PTY LTD, Artarmon (AU)

(72) Inventors: Alexander VIRR, Balmain (AU); Xiaoyi FU, Epping (AU); Dan KAO, Northbridge (AU); John Michael SNOW, Killarney Heights (AU); Damian Charles JOHNSON, Fairlight (AU)

(21) Appl. No.: 15/543,641

(22) PCT Filed: Jan. 14, 2016
(86) PCT No.: PCT/AU2016/050015

§ 371 Date: Jul. 14, 2017

(30) Foreign Application Priority Data
Jan. 14, 2015 (AU) 2015900096

(51) Int. Cl. A62B 18/00; A62B 18/08; A62B 18/02; A62B 9/06; A62B 9/04; A62B 18/10; A62B 7/10

(52) U.S. Cl. CPC A62B 18/006; A62B 18/10; A62B 18/084; A62B 18/082; A62B 7/10; A62B 9/06; A62B 9/04; A62B 18/02

(57) ABSTRACT

A breathing apparatus including a face mask adapted to substantially cover a face of a user and a neck component attached to the face mask and surrounding the user's neck. The face mask has a peripheral region which forms a pneumatic seal against the face and an air inlet arranged proximal to the peripheral region. The neck component houses a flow generator configured to receive unfiltered air from outside of the breathing apparatus, filter the unfiltered air, and convey the filtered air to the face mask through the air inlet.

### TECHNICAL FIELD

The present invention relates generally to a breathing apparatus for providing filtered air to a wearer. In particular, the invention relates to a breathing apparatus having a ‘full face’ mask dimensioned to receive and cover a face of the wearer.

### BACKGROUND TO THE INVENTION

Breathing apparatus, such as powered air purifying respirators (PAPR), are generally used in polluted environments to provide filtered, non-toxic air to a wearer. A PAPR device typically comprises a flow generator for generating filtered air, and a mask for communicating the filtered air to the wearer. The flow generator typically comprises a powered impeller arranged to draw air from the atmosphere and a filter element through which the air is passed and filtered. The filtered air is then conveyed to the wearer via the mask.

PAPR devices are often used in heavily polluted or otherwise hazardous environments, such as industrial areas or hospitals. In particular environments, it is desirable to provide a mask which substantially covers the wearer's face, known as a ‘full face’ mask, to protect the face from particulates or contaminants contacting the face.

Conventional PAPRs are generally bulky, restrict movement of the wearer and are therefore inconvenient and uncomfortable, particularly for prolonged periods of use. This is further exacerbated when a PAPR includes a full face mask, as this typically involves a hose which conveys the filtered air to the mask being connected to the front of the mask. This not only further restricts the movement of the wearer's head but also restricts its vision. These problems can be disincentives for using a PAPR device, potentially meaning that a PAPR is not used and consequently increasing health risks.

Accordingly, it would be useful to provide a breathing apparatus having a full face mask which restricts a wearer's vision and/or movement less than prior art approaches. Furthermore, it would be useful to provide a solution that avoids or ameliorates any of the disadvantages present in the prior art, or which provides another alternative to the prior art approaches.

### SUMMARY OF THE INVENTION

According to one aspect of the invention, there is provided a breathing apparatus comprising a face mask dimensioned to receive a face of a user and defining a peripheral region adapted to form a pneumatic seal against the face, and further comprising an air inlet arranged proximal to the peripheral region, and a neck component attached to the face mask and dimensioned to substantially surround a neck of the user, the neck component including a flow generator configured to receive unfiltered air from outside of the breathing apparatus, filter the unfiltered air, and convey the filtered air to the face mask through the air inlet.

Other aspects are disclosed.

### BRIEF DESCRIPTION OF THE DRAWINGS

Preferred embodiments of the invention will now be described, by way of example only, with reference to the accompanying drawings in which:

FIG. 1 is a perspective view of a breathing apparatus;

FIG. 2A is an exploded view of part of the breathing apparatus shown in FIG. 1;

FIG. 2B is a perspective view of an air inlet valve shown in FIG. 2A;

FIG. 3 is a perspective view of an inner mask of the breathing apparatus shown in FIG. 1;

FIG. 4 is another perspective view of the inner mask shown in FIG. 3;

FIG. 5 is an alternative exploded view of part of the breathing apparatus shown in FIG. 1;

FIGS. 6A to 6C are perspective views of the breathing apparatus shown in the previous figures having a harness arrangement secured thereto; and

FIGS. 7A to 7C are perspective views of part of the breathing apparatus shown in FIG. 1.

### DETAILED DESCRIPTION OF PREFERRED EMBODIMENTS

The present disclosure relates to a breathing apparatus comprising a face mask dimensioned to receive a face of a user and defining a peripheral region adapted to form a pneumatic seal against the face, and further comprising an air inlet arranged proximal to the peripheral region, and a neck component attached to the face mask and dimensioned to substantially surround a neck of the user, the neck component including a flow generator configured to receive unfiltered air from outside of the breathing apparatus, filter the unfiltered air, and convey the filtered air to the face mask through the air inlet.

The disclosed breathing apparatus is a compact design comprising only the face mask and neck component, therefore ensuring the entire apparatus can be worn about the user's head. This is advantageous is this allows relatively free movement of the head and is comfortable to wear and use for prolonged periods.

The apparatus is firmly secured to the head by the face mask being retained relative to the neck component, thereby allowing the peripheral region of the mask to form a pneumatic seal against the face. An air inlet is arranged proximal to this peripheral region through which filtered air is conveyed by the flow generator arranged in the neck component. The position of the air inlet close to, or within, the peripheral region is important, as this prevents the fluid connection between the face mask and the neck component, which provides the filtered air to the user, interrupting the user's field of vision. This may involve the air inlet being arranged proximal to a portion of the peripheral region arranged to seal against the user's cheeks, or lower portion of the face. The arrangement of the air inlet proximal to the peripheral region also ensures the connection is conveniently located to optimise movement of the face mask, thereby enhancing manoeuvrability and comfort of the breathing apparatus.

The face mask typically includes a visor portion arranged at least partially across the face of the user, typically comprising a single surface which substantially covers the face. The air inlet is generally arranged to convey the filtered air into the face mask in a direction which is substantially tangential to the visor portion. This advantageously allows the filtered air to travel unencumbered across the face and access the user's airways, i.e. through the mouth and/or nostrils of the user. Furthermore, the tangential direction of the air inlet also allows the air inlet, and associated conduits or channels connected thereto, to be arranged close to the user's face/head, thereby minimising the size of the breathing apparatus and further enhancing manoeuvrability.

The breathing apparatus may also include an inner mask for covering the mouth and/or nostrils of the user, and conveying exhaled air out of the face mask. The inner mask is typically releasably engageable with the face mask by an engagement mechanism, allowing the inner mask to be readily assembled to the breathing apparatus when required. The engagement mechanism typically includes one or more deformable clips to optimise ease of assembling the inner mask to the face mask. This arrangement is therefore useful, as this allows the breathing apparatus to be conveniently and rapidly configured according to use requirements.

The face mask may include an additional connection to the neck component, being a strap which extends from the face mask, over the user's head, and is secured to the neck component, thereby suspending the neck component from the back of the user's head. The strap typically has a connector for releasably engaging the neck component. This arrangement supports the neck component away from the user's neck, thereby decreasing the load on the neck and improving the manoeuvrability and comfort of the breathing apparatus.

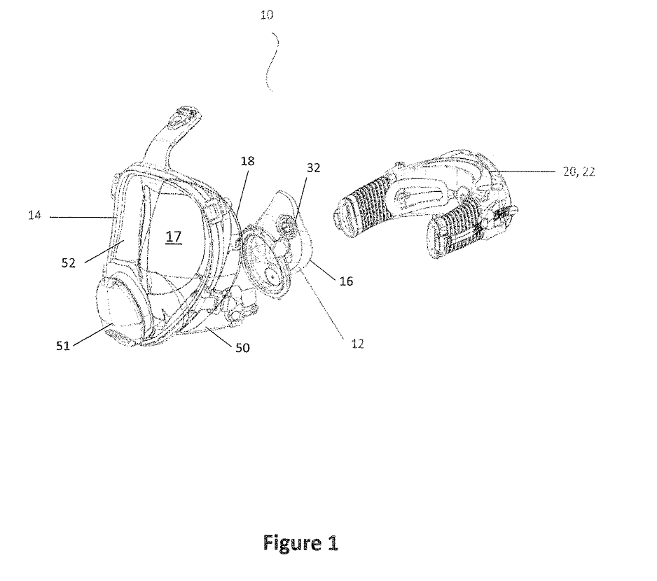

FIG. 1 shows a breathing apparatus 10 comprising a face mask 14 and a neck component 20 housing a flow generator 22. The face mask 14 is dimensioned to receive a face of a user and defines a peripheral region 18 adapted to form a pneumatic seal against the face to create a breathing chamber 17. An air inlet 50 for conveying air into the breathing chamber 17 is arranged proximal to the peripheral region 18. The mask 14 has a visor portion 52 which at least partially, and typically substantially, covers the user's face, therefore providing a viewing window. The air inlet 50 is typically arranged to convey air therethrough substantially tangential to an adjacent portion of the visor 52. An air outlet 51 for conveying air out of the breathing chamber 17 is arranged in a front portion of the face mask 14. Each of the air inlet 50 and air outlet 51 may include a one-way (non-return) valve to control the flow of air therethrough in a single direction. The neck component 20 is releasably connectable to the face mask 14. The connection between the neck component 20 and face mask 14 typically also forms a pneumatic seal between the flow generator 22 and the air inlet 50.

In use, the face mask 14 is placed against the face of the user, forming a seal therebetween, and the neck component 20 connected thereto, thereby securing the breathing apparatus 10 to the user's head. The flow generator 22 is also connected to the air inlet 50 to provide fluid communication therebetween. When operated, the flow generator 22 draws unfiltered air from outside of the breathing apparatus 10, filters the unfiltered air to produce non-toxic, filtered air, and conveys the filtered air through the air inlet 50, into the breathing chamber 17. The user inhales and exhales the filtered air, and the exhaled air passes through the air outlet 51, out of the face mask 14 and away from the breathing apparatus 10.

Optionally, the breathing apparatus further comprises an inner mask 12. The inner mask 12 is dimensioned to receive a mouth and/or nostrils of the user and also defines a peripheral region 16 adapted to form a pneumatic seal against the face. The inner mask 12 is arranged within the breathing chamber 17 and includes one or more air inlets 32 for conveying the filtered air into the inner mask 12, and covers the air outlet 51, thereby allowing exhaled air to be conveyed therethrough. Each air inlet 32 also may include a one-way valve for controlling the flow of air therethrough in a single direction.

The peripheral sealing region 18 of the face mask 14 is typically arranged about a rear portion of the mask 14. The region 18 includes a lower portion arranged to form the pneumatic seal against a corresponding lower portion of the user' face, below the user's eyes. The lower portion also includes opposed cheek portions arranged to form the pneumatic seal against both of the user's cheeks. The air inlet 50 is generally arranged in the lower portion, and often arranged in one, or both, cheek portions. This minimises any visual obstruction caused by the air inlet 50 and also minimises any restriction to movement of the user's head. To further enhance the user's vision when using the apparatus 10 and minimise potential claustrophobic feelings, the face mask 14 and if assembled, the inner mask 12, are substantially transparent or translucent.

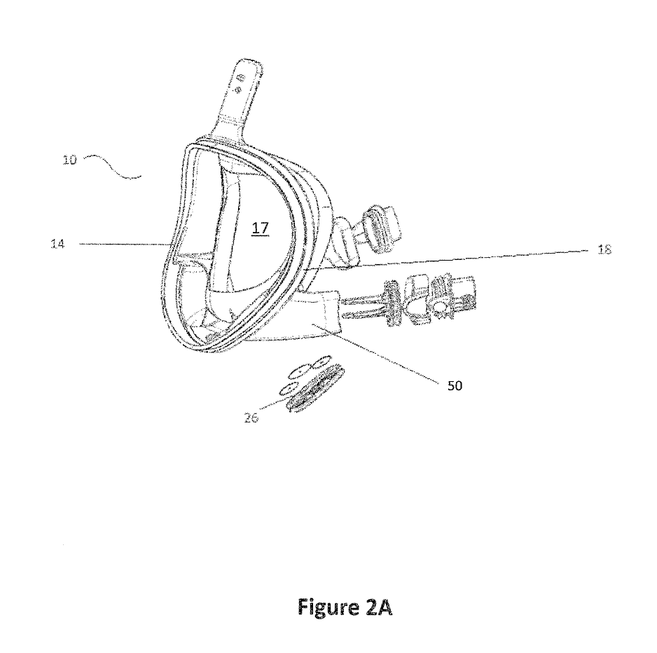

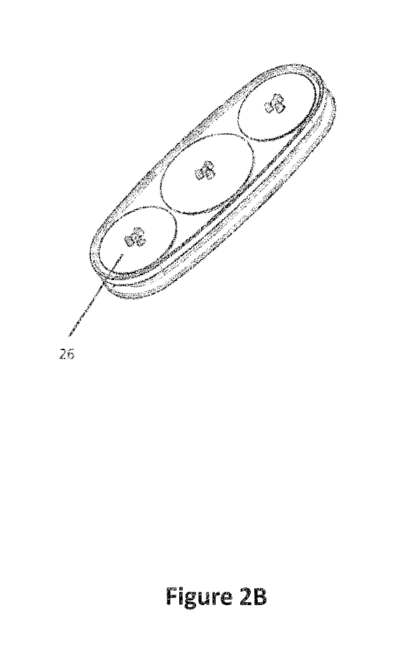

FIG. 2A shows an exploded view of the face mask 14. Shown spaced apart from the air inlet 50 is a non-return valve assembly 26 comprising a row of three valves, although any plurality of non-return valves could be utilised. By having a plurality of non-return valves, the air flow resistance through each valve is reduced, which improves the flow of air into the breathing chamber 17 of the face mask 14. FIG. 2B shows the non-return valve assembly in isolation.

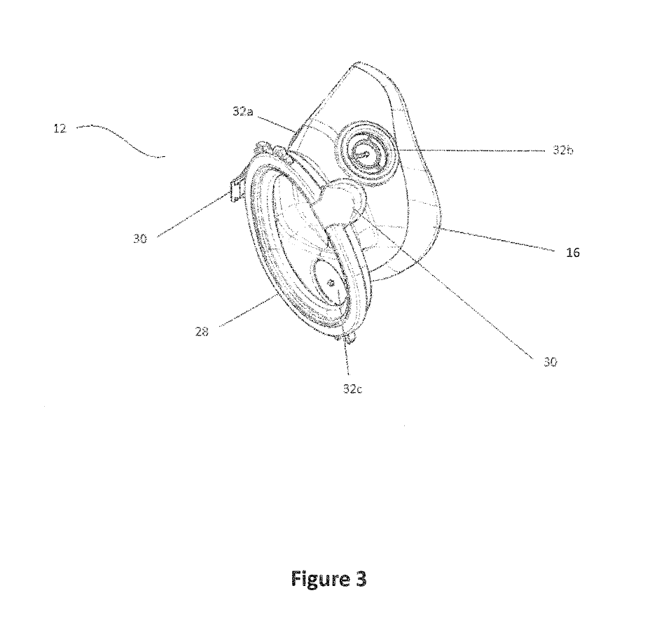

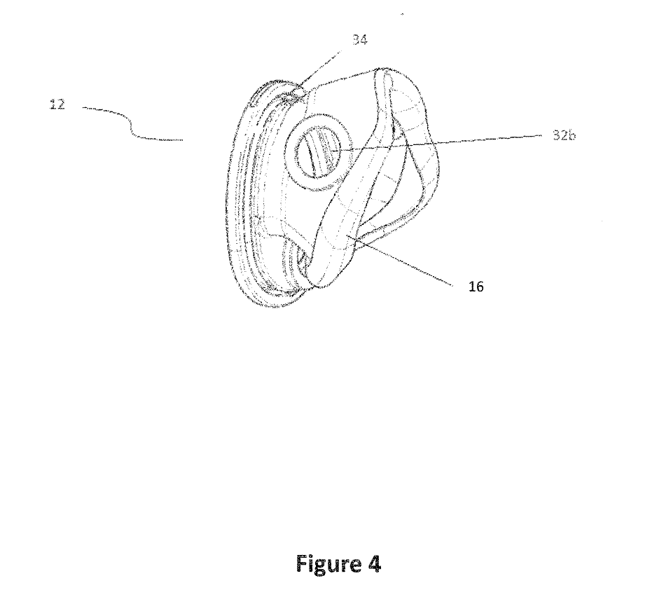

FIGS. 3 and 4 show the inner mask 12 in isolation. The inner mask 12 comprises an engagement mechanism for releasably engaging the inner mask 12 with the face mask 14 and forming a seal therebetween. The engagement mechanism typically includes one or more resiliently deformable clips 30 arranged to engage a rim (not shown) arranged at least partially about the air outlet 51. The engagement mechanism also typically includes a substantially rigid collar 28 dimensioned to abut the rim and form the seal.

FIG. 3 shows three air inlets 32 arranged in the inner mask 12, each housing a one-way valve 32a-32c. A first and second air inlet and associated valves 32a, 32b are arranged in opposed side portions of the mask 12, and a third air inlet and associated valve 32c in a front portion of the mask 12. Typically the peripheral region 16 includes a mouth portion arranged to form the pneumatic seal at least partially around the user's mouth and the front portion is arranged spaced apart from the peripheral region 16 and adjacent to, and typically below, the mouth portion. The arrangement therefore allows three, or potentially more, air inlets 32 to be provided, thereby optimising the rate filtered air is able to flow into the inner mask 12.

Best shown in FIG. 4, the inner mask 12 also includes a nose portion arranged abut the nose of the user and which incorporates a resiliently deformable structure 34 which enables at least a portion thereof to flex to accommodate movement of the user's nose. The resiliently deformable structure 34 typically comprises a bellows arrangement, arranged to compress and expand, thereby enhancing the comfort of the breathing apparatus 10.

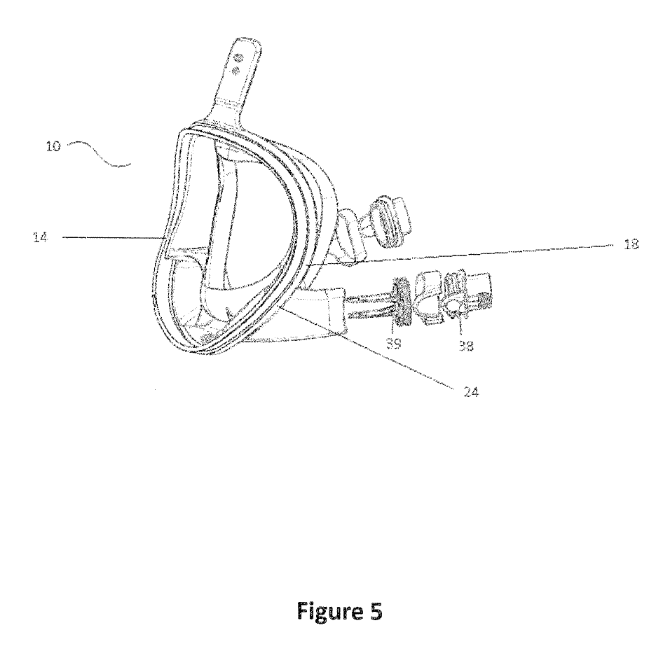

FIG. 5 shows an alternative exploded view of the face mask 14, showing one half of a cooperating mating clip 38 for releasably engaging the face mask 14 with a complementary half of the cooperating mating clip (not shown) affixed to the neck component 20. The clip 38 is shown spaced apart from the air inlet 50 and is typically affixed to the air inlet 50. The other half (not shown) of the clip 38 is typically affixed to an air channel extending from the flow generator 20 and arranged to convey the filtered air therefrom. Mating the two halves of the clip 38 together thereby allows a mechanical and pneumatic connection to be formed between the face mask 14 and the neck component 20. One or more inserts may also be arranged in the air inlet 50 and/or associated air channel to prevent deformation of the channel and/or inlet 50.

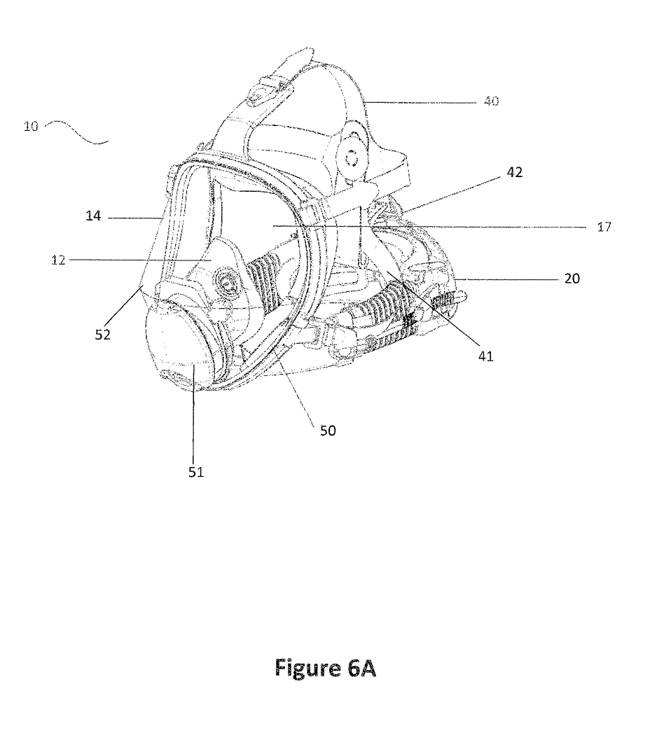

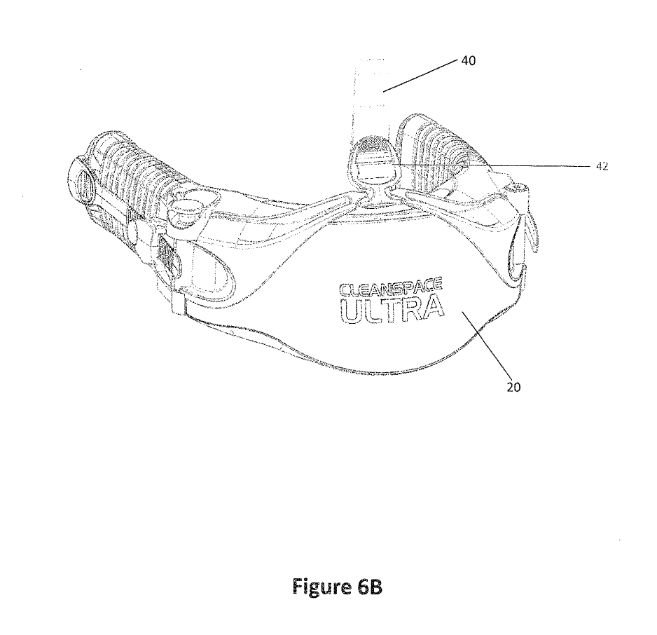

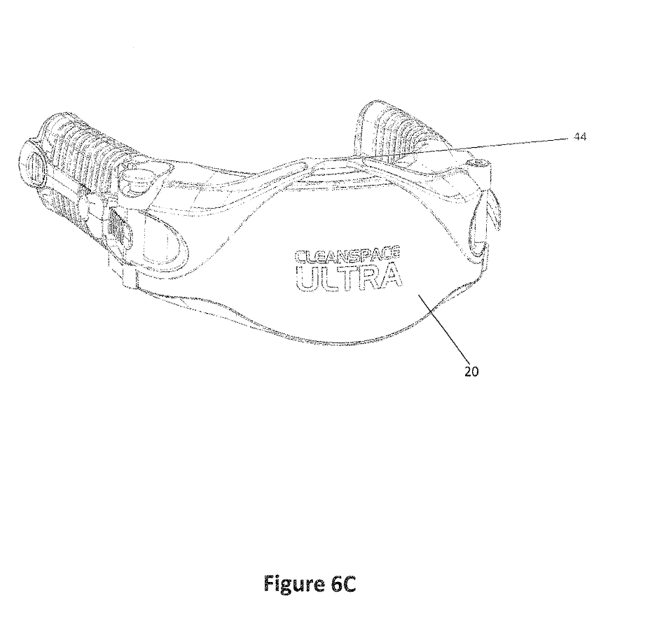

FIGS. 6A to 6C show a harness arrangement attached to the breathing apparatus 10. The harness arrangement connects between the face mask 14 and the neck component 30 to support the weight of the neck component 20 and distribute the load evenly across the user's head.

The neck component 20 connects to opposed sides of the face mask 14 and is arranged to surround the user's neck. The harness arrangement includes a head strap 40 connected between a top portion of the face mask 14 and a top portion of the neck component 20. The head strap 40 may also have mask straps 41 extending therefrom to side portions of the mask 14.

Typically, the head strap 40 is releasably connectable to the neck component 20 with a connector 42 secured thereto, the connector 42 adapted to engage with an attachment point 44 on the neck component. The attachment point 44 is formed along an arched beam extending from a top surface of the neck component 20. The connector 42 is typically a resiliently deformable clip able to engage the attachment point 44 to suspend the neck component 20 from the harness arrangement, thereby reducing the weight of the breathing apparatus 10 supported on the user's neck and/or shoulders. The connector 42 and attachment point 44 are complementarily shaped to facilitate mating and disengagement of the two components, thereby providing a ‘quick release’ system which allows the user to readily secure and remove the neck component 20 to the harness arrangement.

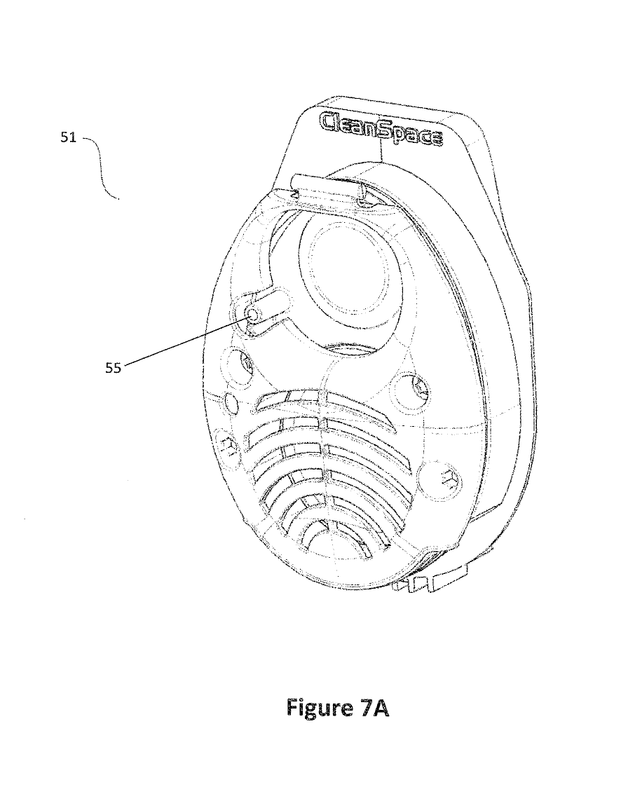

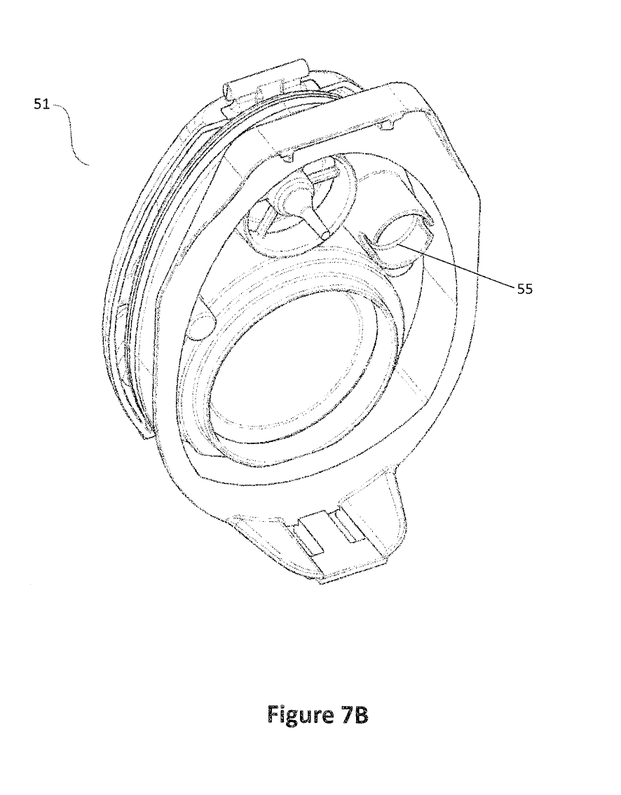

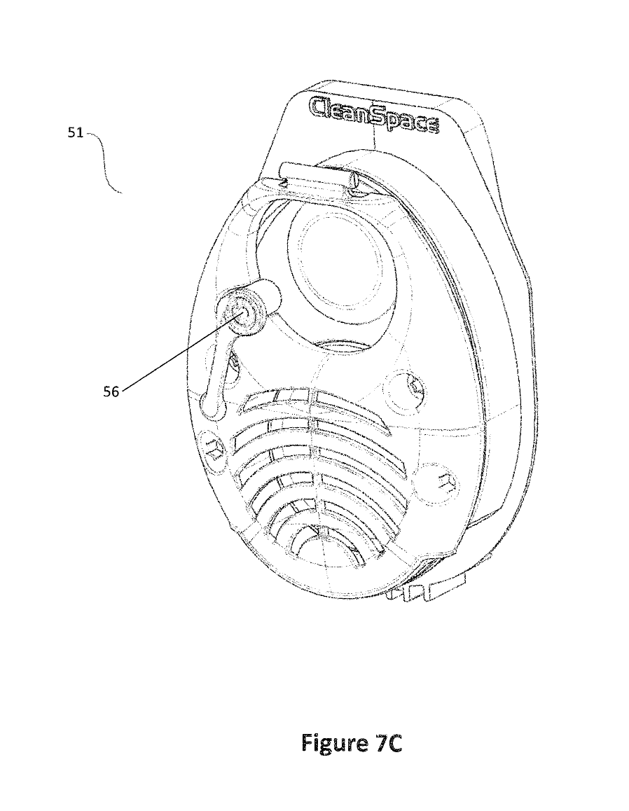

FIGS. 7A to 7C show the air outlet 51 of the face mask 14 in isolation. Optionally, the air outlet 51 further comprises an air quality testing conduit 55 arranged therethrough to allow test equipment (not shown) to be attached at either end thereof to determine air quality within the face mask 14 and potentially also compare this to air quality outside of the face mask 14. Each end of the testing conduit 55 is shaped to engage with the test equipment, typically by frictional engagement. During a ‘normal use’ configuration of the breathing apparatus 10, without testing equipment attached, a plug 56 is frictionally engaged with and seals an external end of the conduit 55, thereby preventing unfiltered air entering the face mask 14. Typically, the testing conduit 55 is arranged through the air outlet 51 to allow the testing equipment connected thereto within the mask 14 to be positioned proximal to the user's mouth, as this is the recommended location for testing air quality. However, whilst the testing conduit 55 is shown formed as an integral part of the air outlet 51 it will be appreciated that the conduit 55 may be formed in another part of the face mask 14.

Whilst the invention is described above with reference to specific embodiments, it will be appreciated that it is not limited to those embodiments and may be embodied in other forms.

1. A breathing apparatus comprising:
a face mask dimensioned to receive a face of a user and defining a peripheral region adapted to form a pneumatic seal against the face, and further comprising an air inlet arranged proximal to the peripheral region; and
a neck component attached to the face mask and dimensioned to substantially surround a neck of the user, the neck component including a flow generator configured to receive unfiltered air from outside of the breathing apparatus, filter the unfiltered air, and convey the filtered air to the face mask through the air inlet.

2. The breathing apparatus according to claim 1, wherein the face mask includes a visor portion arranged to at least partially cover the face, and wherein the air inlet is arranged to convey the filtered air into the face mask substantially tangential to the visor portion.

3. The breathing apparatus according to claim 1, wherein the peripheral region is arranged about a rear portion of the face mask, and wherein the air inlet is arranged within the rear portion.

4. The breathing apparatus according to claim 1, wherein the peripheral region has a lower portion arranged to form the pneumatic seal below the user's eyes, and the air inlet is arranged in the lower portion.

5.-8. (canceled)

9. The breathing apparatus according to claim 1, wherein the face mask further comprises an air outlet for conveying air out of the face mask, and the breathing apparatus further comprises an inner mask dimensioned to receive at least one of a mouth and nostrils of the user and defining a second peripheral region adapted to form a pneumatic seal against the face, the inner mask arranged to convey air through the air outlet and including one or more air inlets having respective one or more one-way valves for directing the filtered air into the inner mask.

10. The breathing apparatus according to claim 9, wherein the inner mask includes an engagement mechanism for releasably engaging the face mask and forming a pneumatic seal therebetween.

11. The breathing apparatus according to claim 10, wherein the inner mask further comprises a rim at least partially surrounding the air outlet and the engagement mechanism includes one or more resiliently deformable clips arranged to engage the rim.

12. The breathing apparatus according to claim 11, wherein the engagement mechanism further comprises a substantially rigid collar dimensioned to abut the rim.

13. The breathing apparatus according to claim 9, wherein the inner mask includes at least three air inlets and respective one-way valves, wherein a first and second air inlet and associated one-way valves are arranged on opposed side portions thereof, and a third air inlet and associated one-way valve is arranged in a front portion thereof.

14. The breathing apparatus according to claim 13, wherein the second peripheral region further comprises a mouth portion arranged to form the pneumatic seal at least partially around the user's mouth, and wherein the front portion is arranged spaced apart from the second peripheral region and adjacent the mouth portion.

15. The breathing apparatus according to claim 9, wherein the inner mask further comprises a nose portion arranged to abut the nose of the user, the nose portion including a resiliently deformable structure for allowing the nose portion to flex.

16. The breathing apparatus according to claim 15, wherein the resiliently deformable structure comprises a bellows arrangement, arranged to compress and expand.

17. The breathing apparatus of claim 1, wherein the face mask is substantially transparent or translucent.

18. The breathing apparatus of claim 9, wherein the face mask and the inner mask are substantially transparent or translucent.

19. The breathing apparatus according to claim 1, wherein the neck component is releasably attached to the face mask by at least one cooperating mating clip, whereby operation of the at least one cooperating mating clip engages the neck component with the face mask and forms a pneumatic seal between the flow generator and the air inlet.

20. The breathing apparatus according to claim 1, wherein the face mask further comprises at least one strap arranged to extend away from the face mask over the user's head, the at least one strap having a connector secured thereto, and wherein the neck component further comprises an engaging portion for engaging the connector, thereby allowing the strap to connect between the face mask and the neck components and suspend the neck component therefrom, behind the user's head.

21. The breathing apparatus according to claim 20, wherein the engaging portion includes a projection extending from a top portion of the neck component and the connector includes a resiliently deformable clip dimensioned to receive and retain the projection.

22. The breathing apparatus according to claim 21, wherein the projection comprises an arched beam.

23. The breathing apparatus according to claim 1, wherein the face mask further comprises a testing conduit arranged therethrough for securing test equipment at each end thereof.

24. The breathing apparatus according to claim 23, wherein the face mask further comprises a plug dimensioned to engage and seal an end of the testing conduit secured thereto.
